(19) United States
(12) Patent Application Publication
(10) Pub. No.: US 2011/0227358 A1
(43) Pub. Date: Sep. 22, 2011

(54) CHOPSTICK WITH ILLUMINANT FUNCTION

(76) Inventor: Hua-Jung CHIU, Jhongli City (TW)

(21) Appl. No.: 12/729,074

(22) Filed: Mar. 22, 2010

(51) Int. Cl. A47G 21/00; A47G 21/10; F21L 4/00

(52) U.S. Cl. 294/218; 362/157

(57) ABSTRACT

A chopstick with an illuminant function includes a chopstick body, a chopstick-cover, a light emitting diode, at least one connecting piece and a switch. A top end of the chopstick body has an accommodating slot formed on an inside thereof, and a first opening connected to the accommodating slot. The chopstick-cover is inserted into the accommodating slot of the chopstick body through the first opening. The chopstick-cover has at least one accommodating space formed on an inside thereof and in communication with the accommodating slot The light emitting diode is disposed on one end of the chopstick-cover. The connecting piece and the switch are arranged in the accommodating space of the chopstick-cover, and the connecting piece is electrically connected to the light emitting diode and the switch. Therefore, the chopstick adds an illuminant function.

### BACKGROUND OF THE INVENTION

1. Field of the Invention

The present invention relates to a chopstick, and particularly to a chopstick with a light emitting diode for illumination.

2. Description of Related Art

With the upgrading of the quality of life, all items become multi-function gradually or have a variety of additional functions. However, a chopstick does not have any change except for retractable and disassemble.

Therefore, the invention provides a chopstick with an illuminant function to mitigate and/or obviate the aforementioned problems.

### SUMMARY OF THE INVENTION

A main object of the present invention is to provide a chopstick with an illuminant function.

To achieve the above-mentioned object, a chopstick with an illuminant function in accordance with the present invention is provided. The chopstick with an illuminant function includes a chopstick body having an accommodating slot formed on an inside thereof and having a first opening in communication with the accommodating slot; a chopstick-cover inserted into the accommodating slot of the chopstick body through the first opening, the chopstick-cover having at least one accommodating space formed on an inside thereof and in communication with the accommodating slot, and the chopstick-cover having a second opening formed on a top end thereof and in communication with the accommodating space; a light emitting diode disposed on an end of the chopstick-cover; at least one connecting piece arranged in the accommodating space of the chopstick-cover and electrically connected to the light emitting diode; and a switch arranged in the accommodating space of the chopstick-cover through the second opening, and the switch electrically connected to the connecting piece.

The chopstick in the present invention adds the illuminant function by a light emitting diode and controls the light emitting diode by a switch.

For further understanding of the present invention, reference is made to the following detailed description illustrating the embodiments and examples of the present invention. The description is for illustrative purpose only and is not intended to limit the scope of the claim.

### BRIEF DESCRIPTION OF THE DRAWINGS

FIG. 1 is a schematic view of the present invention;

FIG. 2 is a cross section view of the present invention;

FIG. 3 is an exploded schematic view of the present invention.

### DETAILED DESCRIPTION OF THE PREFERRED EMBODIMENTS

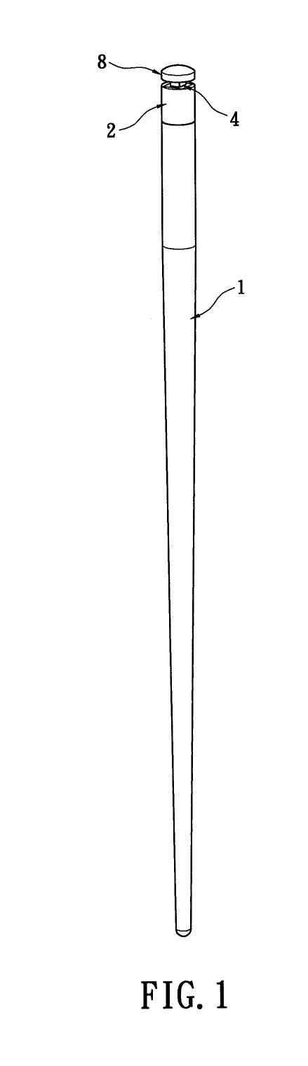

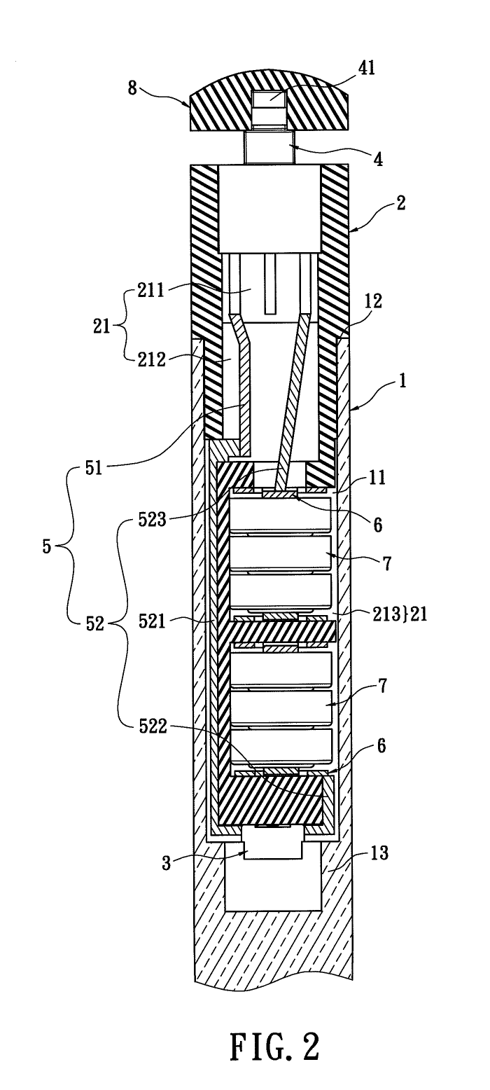

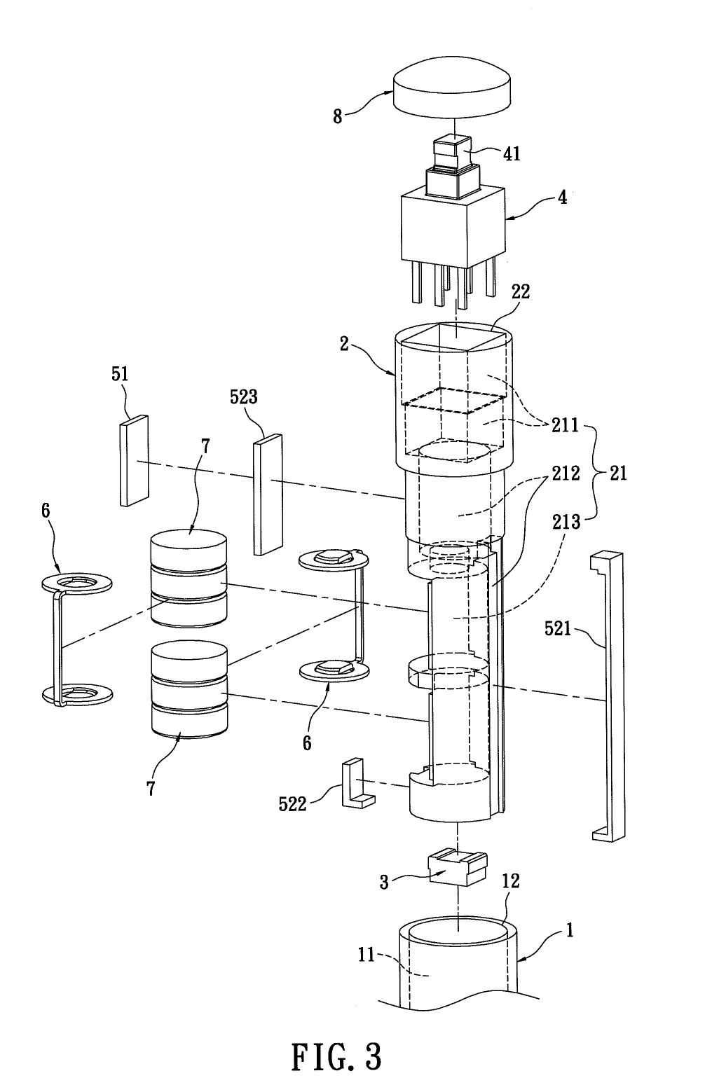

References are made to FIG. 1, FIG. 2 and FIG. 3 illustrating an embodiment of the present invention. The present invention is provided for a chopstick with an illuminant function, which includes: a chopstick body 1, a chopstick-cover 2 disposed on the chopstick body 1, a light emitting diode 3 disposed on a bottom of the chopstick-cover 2, at least one connecting piece 5, and a switch 4.

A top end of the chopstick body 1 has an accommodating slot 11 formed on an inside thereof and a first opening 12 in communication with the accommodating slot 11. A bottom of an inner side of the chopstick body 1 inwardly expands a limited portion 13 presented a ring shape. Besides, the chopstick body 1 is translucent or transparent.

The chopstick-cover 2 has at least one accommodating space 21 formed on an inside thereof, and the chopstick-cover 2 has a second opening 22 formed on a top end thereof and in communication with the accommodating space 21. The chopstick-cover 2 is inserted into the accommodating slot 11 of the chopstick body 1 through the first opening 12, and then edge of the chopstick-cover 2 could be touched with a top surface of the chopstick body 1, an inner surface of the top end of the chopstick body 1, and the limited portion 13. Therefore, the chopstick-cover 2 would not fall and shake.

The accommodating space 21 is divided into a first accommodating space 211, a second accommodating space 212 in communication with the first accommodating space 211, and a third accommodating space 213 in communication with the second accommodating space 212. The second accommodating space 212 and the third accommodating space 213 are located at a bottom of the first accommodating apace 211. The second opening 22 is communicated with the first accommodating space 211, and the switch 4 is inserted into the first accommodating space 211 of the chopstick-cover 2 through the second opening 22.

The second accommodating space 212 of the chopstick-cover 2 is located on an upper side and a lateral side of the third accommodating space 213 of the chopstick-cover 2. The second accommodating space 212 which is formed on the upper side of the third accommodating space 213 of the chopstick-cover 2 is communicated with the first accommodating space 211 and the third accommodating space 213. The second accommodating space 212 which is formed on the lateral side of the third accommodating space 213 of the chopstick-cover 2 is communicated with the accommodating slot 11 and is a trough-like space by concaving one side of the chopstick-cover 2. The third accommodating space 213 is communicated with the accommodating slot 11, and a bottom of the third accommodating space 213 is a trough-like space by concaving another side of the chopstick-cover 2.

The connecting piece 5 is arranged in the accommodating space 21 of the chopstick-cover 2, and the chopstick has at least one metal resilient sheet 6 arranged in the third accommodating space 213 of the chopstick-cover and several batteries 7 clamped by the metal resilient sheet 6. The connecting piece 5 includes a resistance 51 and at least one copper foil 52 electrically connected to the resistance 51. The resistance 51 is electrically connected to one end of the switch 4, and is arranged in the accommodating space 21 of the chopstick-cover 2.

The copper foil 52 includes a first copper foil 521, a second copper foil 522, and a third copper foil 523. The first copper foil 521 is arranged in the first second accommodating space 211 and the second accommodating space 212 of the chopstick-cover 2, and the first copper foil 521 is electrically connected to the resistance 51 and the light emitting diode 3. The second copper foil 522 is arranged in the bottom of the third accommodating space 213 of the chopstick-cover 2, and the second copper foil 522 is electrically connected to the light emitting diode 3 and the metal resilient sheet 6. The third copper foil 523 is arranged in the second accommodating space 212 which is arranged on the lateral side of the third accommodating space 213 of the chopstick-cover 2, and the third copper foil 523 is electrically connected to the metal resilient sheet 6 and another end of the switch 4.

The switch 4 includes a button 41 protruded from the second opening 22 of the chopstick-cover 2 and a switch-cover 8 wedged on the button 41.

An electric circuit of the switch 4 could be conducted by pressing the switch-cover 8, and then the batteries 7 could output the electric energy to the light emitting diode 3 through the metal resilient sheet 6, the connecting piece 5, and the switch 4 for illuminating the chopstick body 1. If pressing the switch-cover 8 again, the electric circuit of the switch 4 couldn't be conducted, and then the batteries 7 could stop to output the electric energy to the light emitting diode 3. Therefore, the light emitting diode 3 doesn't illuminate.

The chopstick in the present invention adds the illuminant function by the light emitting diode 3 and controls the light emitting diode 3 by a switch 4.

The description above only illustrates specific embodiments and examples of the present invention. The present invention should therefore cover various modifications and variations made to the herein-described structure and operations of the present invention, provided they fall within the scope of the present invention as defined in the following appended claims.

What is claimed is:

1. A chopstick with an illuminant function, comprising:
a chopstick body having an accommodating slot formed on an inside thereof, and a first opening in communication with the accommodating slot;
a chopstick-cover inserted into the accommodating slot of the chopstick body through the first opening, the chopstick-cover having at least one accommodating space formed on an inside thereof and in communication with the accommodating slot, and the chopstick-cover having a second opening formed on a top end thereof and in communication with the accommodating space;
a light emitting diode disposed on an end of the chopstick-cover;
at least one connecting piece arranged in the accommodating space of the chopstick-cover; and
a switch arranged in the accommodating space of the chopstick-cover-through the second opening, and the switch electrically connected to the light emitting diode through the connecting piece.

2. The chopstick as claimed in claim 1, wherein the chopstick body is translucent or transparent.

3. The chopstick as claimed in claim 1, wherein the accommodating space is divided into a first accommodating space, a second accommodating space in communication with the first accommodating space, and a third accommodating space in communication with the second accommodating space, and the second opening is in communication with the first accommodating space of the chopstick-cover.

4. The chopstick as claimed in claim 3, wherein the switch is arranged in the first accommodating space of the chopstick-cover through the second opening, and the second accommodating space is in communication with the accommodating slot.

5. The chopstick as claimed in claim 4, further comprising at least one metal resilient sheet for electrically connecting the connecting piece and clamping several batteries, wherein the third accommodating space is communicated with the accommodating slot, and the metal resilient sheet is arranged in the third accommodating space of the chopstick-cover.

6. The chopstick as claimed in claim 5, wherein the connecting piece includes a resistance electrically connected to one end of the switch, and at least one copper foil electrically connected to the resistance, the metal resilient sheet, the light emitting diode, and another end of the switch.

7. The chopstick as claimed in claim 6, wherein the copper foil includes a first copper foil electrically connected to the resistance and the light emitting diode, a second copper foil electrically connected to the light emitting diode and the metal resilient sheet, and a third copper foil electrically connected to the metal resilient sheet and another end of the switch.

8. The chopstick as claimed in claim 1, wherein the switch further comprises a switch-cover disposed on a top end thereof.

9. The chopstick as claimed in claim 1, further comprising at least one metal resilient sheet for electrically connecting the connecting piece and clamping several batteries, wherein the metal resilient sheet is arranged in the accommodating space of the chopstick-cover.

10. The chopstick as claimed in claim 1, wherein the light emitting diode is disposed on a bottom of the chopstick-cover.
